(19) United States
(12) Patent Application Publication
(10) Pub. No.: US 2014/0362178 A1
(43) Pub. Date: Dec. 11, 2014

(54) Novel Transcoder and 3D Video Editor

(71) Applicant: Ingo Nadler, Bonn (DE)

(72) Inventor: Ingo Nadler, Bonn (DE)

(21) Appl. No.: 13/848,052

(22) Filed: Mar. 20, 2013

Related U.S. Application Data
(63) Continuation-in-part of application No. 13/229,718, filed on Sep. 10, 2011, now abandoned.
(60) Provisional application No. 61/381,915, filed on Sep. 10, 2010.
(60) Provisional application No. 61/613,291, filed on Mar. 20, 2012.

(51) Int. Cl. H04N 13/00

(52) U.S. Cl. CPC H04N 13/0022; H04N 13/0059; H04N 13/0062
USPC 348/43

(57) ABSTRACT

A system and method for conducting 3D image analysis, generating a lossless stereoscopic master file, uploading the lossless stereoscopic master file to editing software, wherein the editing software generates a disparity map, analyzes a disparity map, analyzes cuts, and creates cut and disparity meta-information, and then scaling media, storing media and streaming the media for playback on a 3D capable viewer is provided.

### CROSS-REFERENCE TO RELATED APPLICATIONS

This application is a continuation-in-part of U.S. patent application Ser. No. 13/229,718 filed Sep. 10, 2011, which claims the benefit of U.S. Provisional Patent Application No. 61/381,915, filed Sep. 10, 2010. This application also claims the benefit of U.S. Provisional Patent Application No. 61/613,291, filed Mar. 20,2012. The disclosures of each of the foregoing applications are incorporated herein by reference in their entirety.

### FIELD OF THE INVENTION

The invention relates generally to a transcoder for converting any three-dimensional video format into one or more three-dimensional video formats capable of display on high definition television sets and other display devices and which is capable of post-production editing to enhance video quality and viewability.

### BACKGROUND

Three dimensional video is available in a wide variety of three-dimensional video formats such as side by side, frame compatible, anamorphic side by side, variable anamorphic side by side, top/down, frame sequential or field sequential. In order to display all these formatted videos on a display device they are typically transcoded into a three-dimensional video format acceptable to the display device. Transcoding works by decoding the original data/file to an intermediate uncompressed format (i.e. PCM for audio or YUV for video), which is then encoded into the target format.

Playback devices such as high definition televisions, flat screen computer monitors and other display devices capable of displaying three-dimensional (“3D”) video typically accept only a limited set of formats (“display formats”), in some instances only one display format is accepted by the display device. Furthermore, common display device screen parameters differ from the screen parameters in which many 3D videos were originally shot and produced. When three dimensional video shot and stored in a particular format is transcoded into these acceptable display formats, the 3D video is often distorted and sometimes un-viewable. There exists a need for an advanced transcoder which is capable of converting all of the known 3D video formats into display ready 3D formats and which is capable of significant production level editing of the video when encoding the video into one or more of the display formats.

### SUMMARY OF THE INVENTION

In an aspect of the present invention a system and method for conducting 3D image analysis, generating a lossless stereoscopic master file, uploading the lossless stereoscopic master file to editing software, wherein the editing software generates a disparity map, analyzes a disparity map, analyzes cuts, and creates cut and disparity meta-information, and then scaling media, storing media and streaming the media for playback on a 3D capable viewer is provided.

### BRIEF DESCRIPTION OF THE DRAWINGS

FIG. 1 depicts a flow chart of the transcoding process of embodiments of the present invention.

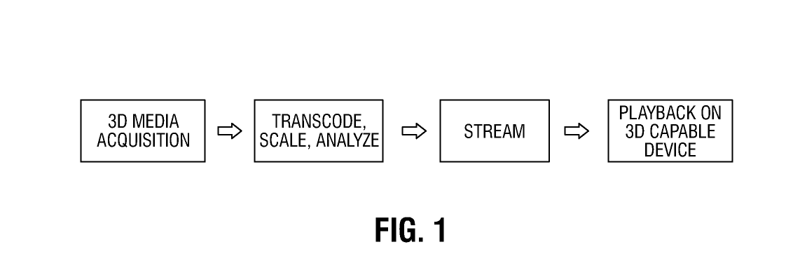

FIG. 2 depicts a flow chart of the transcoding and 3D editing process of embodiments of the present invention.

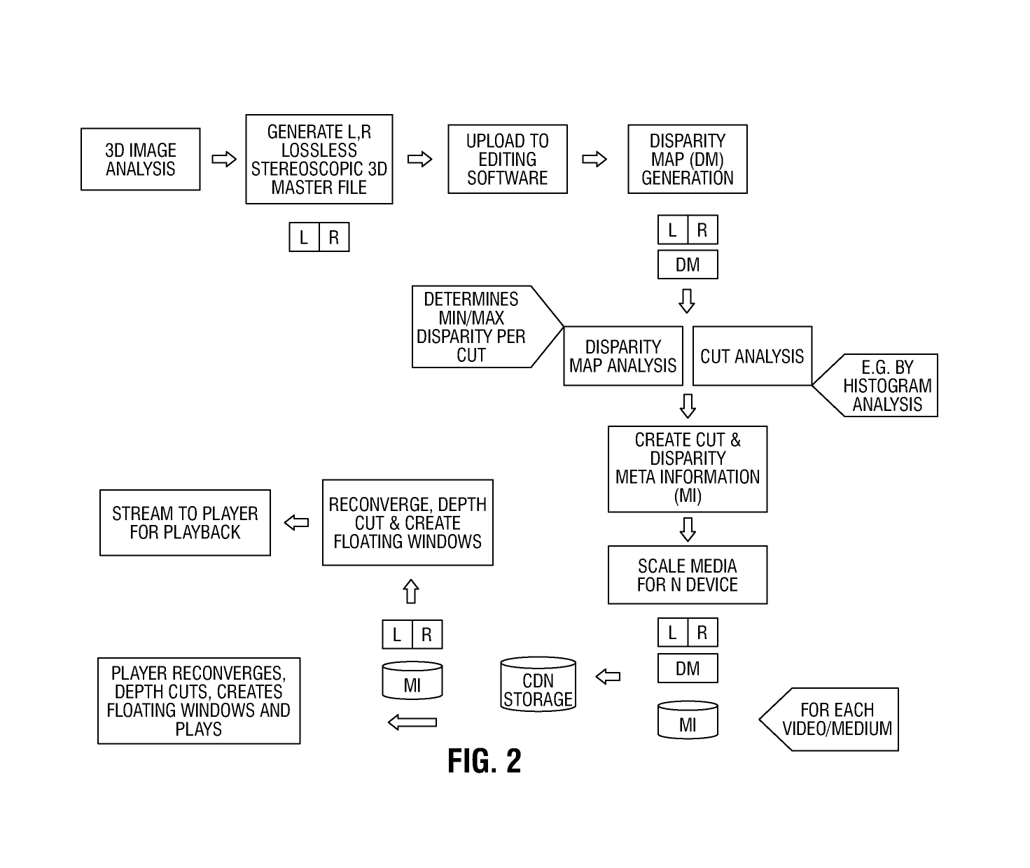

FIG. 3 depicts scene shifting to fit cameras into the comfort zone of a playback device.

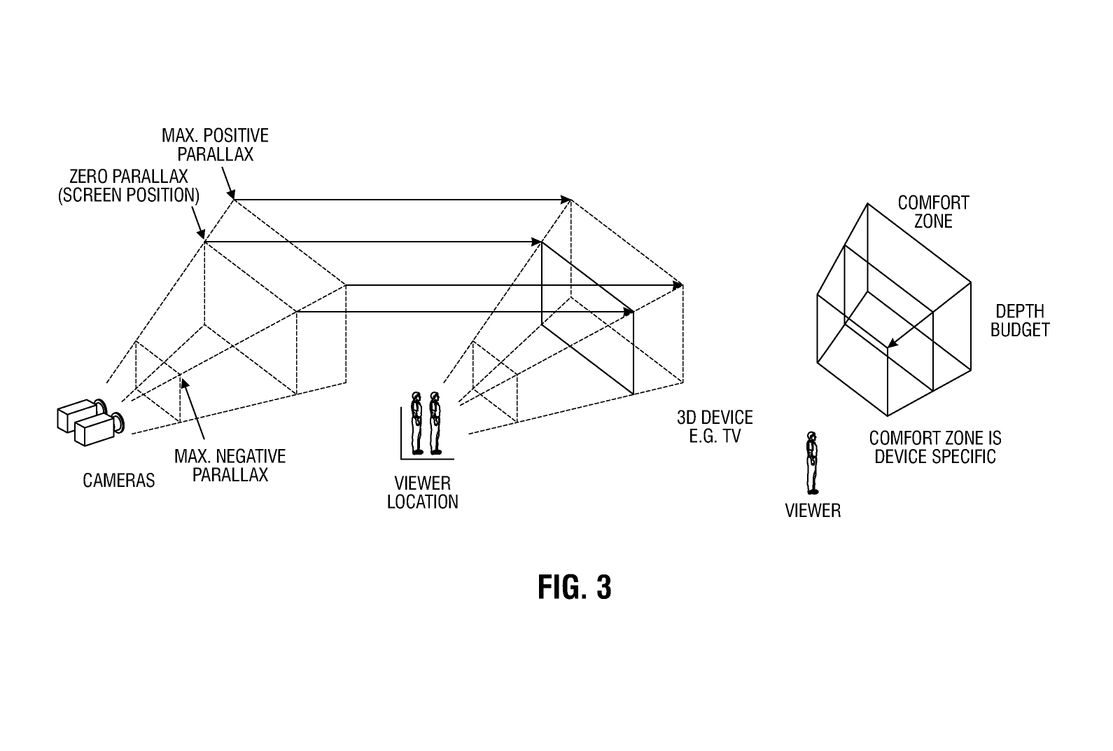

### DETAILED DESCRIPTION

In the following detailed description of embodiments of the invention, numerous specific details are set forth in order to provide a thorough understanding of the embodiment of invention. However, it will be obvious to a person skilled in art that the embodiments of invention may be practiced with or without these specific details. In other instances methods, procedures and components known to persons of ordinary skill in the art have not been described in details so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

The present invention provides a system and a method used thereof for transcoding and editing three dimensional video. The system includes a plurality of software modules to effect the method, which either run locally on a client device, on a server, or in a cloud computing environment which provide transcoded and edited three dimensional video files to a playback device. The client device, server, cloud network and playback device are preferably connected to each other via the Internet, a dedicated cable connection, such as cable television, or a combination of the two, including wireless networks such as wifi, 4G or 3G connections or the like. Wireless connectivity between the playback device and the server or client conducting the transcoding and editing is also possible.

In an embodiment of the present invention, a transcoder module resides on a server which has communication with cloud storage network capable of storing three dimensional video files. A user of the system, upon logging into his account, is able to upload to cloud storage copies of their personal three dimensional video collection or of any three dimensional video file to which they have access. Next, in the media acquisition step, the 3D video content (media) is acquired by the server or other device which will conduct the transcoding, for example media may be acquired from the cloud storage. The acquired media may be any 3D format such as side by side, frame compatible, anamorphic side by side, variable anamorphic side by side, top/down, frame sequential or field sequential. After media acquisition, image analysis of the 3D media is conducted by analysis software code which determines aspect ratio and resolution and optionally provides content analysis and a color histogram. From the data generated the analysis software is able to determine the input format of the 3D media. The 3D media input is then decoded and encoded into a lossless format, such as SBS, to form a stereoscopic master. The stereoscopic master may be stored in memory or on a cloud storage network or other storage device. The stereoscopic master file, may then be transcoded a lossy format for streaming to playback devices. The lossy format is selected based on the playback device the user has registered with their user account or which has been auto-detected by the transcoder module. Examples of lossy formats currently accepted by playback devices include SBS_{A} and Anaglyph, which are frame compatible metaformats which also save bandwidth as compared to other 3D formats. SBS_{A} is preferable because it is frame compatible with existing cable transmission systems, broadcast television and satellite television systems and compressible. These frame compatible metaformats may be stored in various resolutions on a content delivery network or other storage mechanism connected to the playback device. Where the playback device has computing power, such as a personal computer (PC) with a 3D capable screen, and is capable of or requires the display of other 3D formats, the playback device may transcode the frame compatible metaformat into any 3D format the display requires via its own playback device transcoder, thus saving bandwidth. Alternatively the frame compatible metaformat is not limited to SBS_{A} and Anaglyph and may be any 3D format, but is preferably a 3D format accepted by existing 3D playback devices. Thus for example, where the playback device is a PC with a 3D display capability, the metaformat streamed to the PC will already be the 3D format required or accepted by the PC's display device, thus eliminating the need to transcode the streamed format into a displayable format at the PC client. Furthermore, the frame compatible metaformat may be streamed on the fly to the playback device as it is generated by the transcoder module.

In another embodiment of the present invention, the lossless stereoscopic masterfile may be edited to enhance viewability and user experience prior to encoding into a frame compatible metaformat for streaming to a playback device. In this embodiment the presence of the lossless stereoscopic master file is taken advantage of to create data which when encoded into a frame compatible metaformat will not create artifacts or perpetuate artifacts or errors in the original 3D media. For example, (a) gigantism effect (where close up objects appear too large), (b) miniaturization effect (where distant objects look tiny), (c) roundness (where objects flatten), (d) depth cuts (camera distance changes between scenes), (e) depth cues (edge effect—where an object is cut by the frame, loss of 3D perception occurs), and (f) depth budget/comfort zone effects (where a film is shot with a certain parallax range and the display device's capabilities are below range, resulting in objects appearing too close to one another).

First a disparity map is generated from the stereoscopic master, then the data for left and right images plus the disparity map data are transferred for cut analysis (for example by histogram differentiation) and disparity map analysis (determining the minimum and maximum disparity per cut). The output of the cut and disparity map analyses are then stored as cut and disparity map meta-information which is used to generate corrected frame compatible metaformats for each playback device which include data (the meta-information) necessary to correct artifacts and errors present in the original 3D media. The meta-information may be embedded into the frame compatible metaformat, for example as a header, or provided separately with a time code. More particularly, meta-information generated from cut and disparity analysis includes a time code for each cut and a maximum negative parallax and maximum positive parallax for the start and end of each cut. These corrected frame compatible metaformats may then be stored on a content delivery network for streaming to playback devices, or streamed on the fly to the playback device.

The playback device utilizes the meta-information to reconverge, create depth cuts, shift scenes (to fit the playback into playback device comfort zones) and create floating windows to correct the 3D media. Alternatively the reconverge, depth cuts, scene shifts and floating windows may be generated prior to transmission to the playback device, for example on a remote server or other connected computing device and then streamed to the playback device along with the frame compatible metaformat. When making depth cuts, a dynamic parallax shift is made to accommodate strong parallax changes between scenes.

In another embodiment a table of minimum and maximum parallax values is created from the lossless stereoscopic master file. Using these values the playback device may resolve depth cue conflicts, reduce depth cut effects between scene changes and reformat the film to reduce comfort zone effects caused by differences between the parallax range the film was originally shot with and the parallax range of the playback device.

In embodiments of the present invention the disparity map and cut analysis data or the parallax min/max data (both referred to as the meta-information), are utilized to re-render the film by applying a linear or nonlinear transformation function that modifies pixel X values depending on a preset value for Z, the expected distance of the viewer to the screen. Thus camera distance and distance between objects can be adjusted and multi-view camera perspectives or auto-stereoscopic effects created. Examples of linear and nonlinear transformation functions useful with the embodiments of the present invention can be found in U.S. patent application Ser. No. 13/229,718, the disclosure of which is hereby incorporated by reference.

In a further embodiment of the present invention, certain 3D media may be rejected at the cut and disparity map analysis phase, where it is determined by the analysis module that screen depth differences between the original film and the playback device deviates from a predetermined table of acceptable parameters for playback devices. Users are then informed that the particular 3D media is incompatible with their existing playback device, by for example a pop-up message transmitted to their playback device.

In order to upload 3D media to the content delivery system, in embodiments of the present invention upload manager software and masterfile creator software may reside on the client or server. Where the manager and creator software are client side, the lossless stereoscopic master file is created from locally stored 3D media and uploaded to the content delivery network. Editing of the film to correct artifacts and errors may also be accomplished by client side software as described previously and then uploaded along with the stereoscopic master file. Alternatively, as described herein, the original 3D media could be uploaded by a user to a remote cloud storage or other networked storage system, and the masterfile generated by a remote sever which in conjunction with other remote servers carries out any editing functions. Still further all of the software described herein may reside locally, and serve stream properly formatted 3D content over a home network to a connected 3D playback device.

1. A transcoder comprising:
(a) software code capable of conducting 3D image analysis,
(b) software code capable of generating a lossless stereoscopic master file
(c) software code capable of uploading the lossless stereoscopic master file to editing software, wherein the editing software generates a disparity map, analyzes a disparity map, analyzes cuts, and creates cut and disparity meta-information,
(d) software code capable of scaling media, storing media and streaming the media for playback on a 3D capable viewer.
